(19) United States
(12) Patent Application Publication
(10) Pub. No.: US 2016/0269272 A1
(43) Pub. Date: Sep. 15, 2016

(54) CONTENT-BASED ROUTING METHOD AND SYSTEM

(71) Applicant: PEKING UNIVERSITY SHENZHEN GRADUATE SCHOOL, Shenzhen (CN)

(72) Inventors: Hui LI, Shenzhen (CN); Fuxing CHEN, Shenzhen (CN); Wensheng CHEN, Shenzhen (CN)

(21) Appl. No.: 15/161,275

(22) Filed: May 22, 2016

Related U.S. Application Data
(63) Continuation-in-part of application No. PCT/CN2014/093966, filed on Dec. 16, 2014.

(51) Int. Cl. H04L 12/751; H04L 12/741; G06F 17/30; H04L 12/721; H04L 12/747; H04L 12/717; H04L 12/733

(52) U.S. Cl. CPC H04L 45/02; H04L 45/42; H04L 45/54; H04L 45/122; H04L 45/123; H04L 45/742; G06F 17/30952

(57) ABSTRACT

A content-based routing method, including: a) performing routing topology discovery and maintenance, centralized routing computation, and routing information inquiry by a name routing center of a controller; b) caching an active routing information by a forwarding information base; and c) acquiring inquired information of a routing node and updating the forwarding information base by the name routing center of the controller.

### CROSS-REFERENCE TO RELATED APPLICATIONS

This application is a continuation-in-part of International Patent Application No. PCT/CN2014/093966 with an international filing date of Dec. 16, 2014, designating the United States, now pending. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

1. Field of the Invention

The invention relates to content-based routing method and system.

2. Description of the Related Art

A typical content centric networking (CCN) adopts a named-data link state routing (NLSR) protocol, in which, each routing node calculates the entire network topology and routing by the distributed routing algorithm and stores the content name prefixes of the entire network. However, the number of the content name prefixes is much higher than the number of IP addresses and rapidly increases, and each router tries to build a forwarding information base (FIB) of the entire network, thus a huge or even unsolvable storage resource is demanded. In addition, each router is required to accomplish the synchronization of the link state database (LSDB), the topology discovery of the entire network, and the routing computation, with the expansion of the routing table, a large amount of bandwidth is occupied, an excessive computing resource is consumed, and the computing redundancy is resulted.

### SUMMARY OF THE INVENTION

In view of the above-described problems, it is one objective of the invention to provide content-based routing method and system that are adapted to solve the problems that the router in the prior art demands a large amount or even unsolvable storage resource and that the routing computation consumes excessive computing resource and exists with computing redundancy.

To achieve the above objective, in accordance with one embodiment of the invention, there is provided a content-based routing method. The method comprises: a) performing routing topology discovery and maintenance, centralized routing computation, and routing information inquiry by a name routing center (NRC) of a controller; b) caching an active routing information by an FIB; and c) acquiring inquired information of a routing node and updating the FIB by the NRC of the controller.

In a class of this embodiment, in step a), after acquiring link state advertisements (LSAs) from the routing node, the NRC of the controller adds the LSAs to a LSDB; the NRC then establishes an entire network topology and computes the routing, and establishes a hash list of one element for each router so as to enable name link state advertisements (NLSAs) to correspond with adjacency link state advertisements (ALSAs).

In a class of this embodiment, a multi-source shortest path is computed in a) after an entire network topology is built by the NRC, and corresponding parts of a routing information base (RIB) are returned to the routing nodes. Entries of the FIB are returned to the routing nodes in the form of a set which comprises routers and content name prefixes of the entire network, and each router reinstalls the FIB. When a number of the entries is larger than a set threshold, a part of the entries are selected as the FIB of each routing node.

In a class of this embodiment, the routing node distributes its LSAs and sends an Info interest packet to directly connected routers to acquire a link state information.

In a class of this embodiment, the method further comprises operation of the routing node when receiving an Interest packet in c): c1) searching a content store: when a matching request content is found in the content store, sending the content to a request port, otherwise, forwarding the request content to a pending information table (PIT); c2) searching the PIT: when one Interest in the PIT matches, which means that an information of the same Interest has been forwarded and is still waiting, adding a port the latest Interest information arrived on to the PIT, otherwise, searching the FIB; c3) searching the FIB: when a next hop routing which matches the Interest packet is found in the FIB, forwarding the Interest packet to a next hop router, and adding the waiting information of the Interest packet to the PIT; otherwise, sending a query command to search the NRC; and c4) searching a RIB: searching a corresponding entry of the FIB by the NRC according to its RIB, and returning the corresponding entry of the FIB to the routing node.

In a class of this embodiment, the routing computation of a) comprises: acquiring the LSAs from each router to build a LSDB of an entire network, wherein an ALSA comprises link information from one router to another router; establishing a matrix W, wherein Wᵢⱼ represents a link cost from router i to router j, computing a shortest path between any two nodes and a next hop by a Floyd algorithm, and recomputing the routing or incrementally computing the routing every time the adjacency LSA changes; defining dᵢⱼ^{(k)} as a shortest path weight from node i to j, in which numbers of all intermediate nodes on paths from node i to j are selected from a set {1, 2, . . . , k}; when k=0, no intermediate node exists on a path from node i to j not containing intermediate nodes labeled with a number larger than 0, dᵢⱼ⁽⁰⁾=Wᵢⱼ; and recursively defining dᵢⱼ^{(k)} as

$$follows \text{:} {d}_{ij}^{( k )} = \{ \begin{matrix}{W}_{ij} & k = 0 \\ min ( {d}_{ij}^{( k - 1 )} , {d}_{ik}^{( k - 1 )} + {d}_{kj}^{( k - 1 )} ) & k \geq 1 ,\end{matrix}$$

and obtaining the matrix D^{(n)=(d}ᵢⱼ⁽ⁿ⁾) as a final shortest path.

In a class of this embodiment, two threads are realized in a process of the routing node in c); and one thread is responsible for detecting and gathering link states and building a local LSDB, and the other thread is responsible for receiving and installing entries of the FIB distributed from the controller.

In a class of this embodiment, the routing node only maintains a link state between directly connected routers and itself.

In a class of this embodiment, the NRC manages entire network routing, and each router adopts a lookup-and-cache module.

In accordance with another embodiment of the invention, there is provided a content-based routing system. The system comprises: a NRC of a controller and multiple routing nodes connected thereto. The NRC of a controller is responsible for routing topology discovery and maintenance, centralized routing computation, and routing information inquiry. Two threads are realized in a process of each routing node. One thread is responsible for detecting and gathering link states and building a local LSDB, and the other thread is responsible for receiving and installing entries of a FIB distributed from the controller. The NRC is also responsible for gathering the LSDB of each router, routing computation, and distributing routing table entries. The routing node only maintains a link state between directly connected routers and itself.

Advantages of content-based routing method and system according to embodiments of the invention are summarized as follows: the method and the system of the invention are able to tackle the problems of too large the routing table at the router terminal. Each router node is only responsible for maintaining the link state between the directly connected routers and itself rather than synchronizing the link state of the entire network, so that a large amount of bandwidth consumption for the synchronization of the link state of the router is reduced. The NRC of the invention is responsible for the topology discovery of the entire network and the routing computation, thus effectively reducing the redundancy of the computation resource and improving the efficiency.

### BRIEF DESCRIPTION OF THE DRAWINGS

The invention is described hereinbelow with reference to the accompanying drawings, in which:

FIG. 1 is a schematic diagram illustrating a Lookup-and-Cache mechanism in a content-based routing method in accordance with one embodiment of the invention;

FIG. 2 is a structure diagram of a content-based routing system in accordance with one embodiment of the invention; and

FIGS. 3A-3C are flow charts for realizing functions of routers and a controller in accordance with one embodiment of the invention.

### DETAILED DESCRIPTION OF THE EMBODIMENTS

For further illustrating the invention, experiments detailing content-based routing method and system are described below. It should be noted that the following examples are intended to describe and not to limit the invention.

Related network terms are introduced hereinbelow:

SDN: Software Defined Network

CCN: Content Centric Networking

NLSR: Named-data Link State Routing Protocol

LSDB: Link State Database

LSA: Link State Advertisement

NBCR: Name Based Centralized Routing

NRC: Name Routing Center

FIB: Forwarding Information Base

CS: Content Store

PIT: Pending Information Table

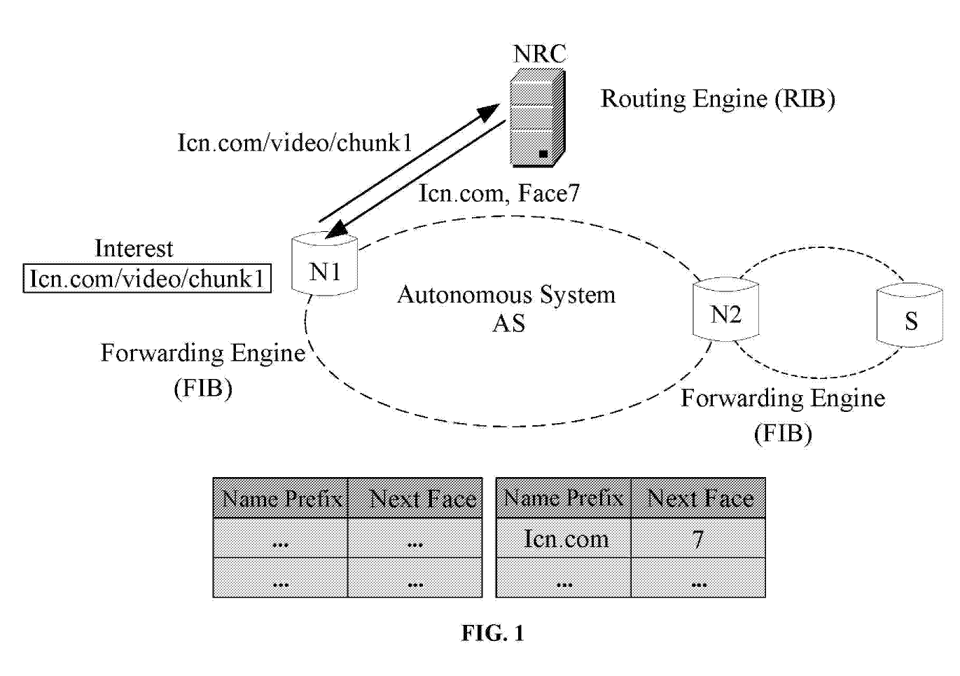

The concept and the application example of Lookup-and-Cache are explained in FIG. 1. a) An NRC is responsible for routing topology discovery and maintenance, centralized routing computation, and routing information inquiry; b) An FIB functions as a cache for routing transfer and only caches an active part of a routing table; c) when a routing node lacks for a certain routing information, the routing node inquires the routing information to the NRC. When a node N1 receives an interest packet “icn.com/video/chunkl” and the node N1 lacks for related routing information, the node N1 first stories the interest packet in an information queue temporarily, sends out an inquiry about the routing information to the remote NRC system, and then inserts the inquired routing information into the original FIB or replaces an original routing information in the original FIB with the inquired routing information. For the full-loaded FIB, replacement algorithms, including the inactivity time out (ITO) and the least recently used (LRU), are adopted for the replacement.

Specifically:

1) When starting a router, a routing node process reads configuration documents and acquires configurations of router names, content name prefixes, directly connected router names, and link costs, etc.

2) The routing node distributes its LSAs, including adjacency LSA and name LSAs, and sends out an Info interest packet to the directly connected routers to acquire a link state information.

3) Each router distributes the LSAs to the NRC and the NRC establishes an LSDB of the entire network according to the LSAs of each router.

4) The NRC computes the routing information, and stores the routing information in an RIB, and extracts FIB information of each routing node and distributes the FIB information to corresponding routing nodes.

5) Mechanism of a name based centralized routing is as follows: when the routing node receives the Interest packet:

a) searching a content store: when a matching request content is found in the content store, sending the content to a request port, otherwise, forwarding the request content to a PIT;

b) searching the PIT: when one Interest in the PIT matches, which means that an information of the same Interest has been forwarded and is still waiting, adding a port the latest Interest information arrived on to the PIT, otherwise, searching the FIB;

c) searching the FIB: when a next hop routing which matches the Interest packet is found in the FIB, forwarding the Interest packet to a next hop router, and adding the waiting information of the Interest packet to the PIT; otherwise, sending a query command to search the NRC; and

d) searching the RIB table: searching a corresponding FIB entry by the NRC according to its RIB table, and returning the corresponding FIB entry to the routing node via an expanded OpenFlow protocol.

6) When the data packet is received, the field of the content name of the data packet is performed with longest prefix match. The matching is first performed in the content store (if matches, then the Interest will be discarded), otherwise the matching is then performed in the PIT (when there is matched items in the PIT, the Interest is forwarded to the requester and cached in the content store, if there is no matched items, the Interest will be discarded).

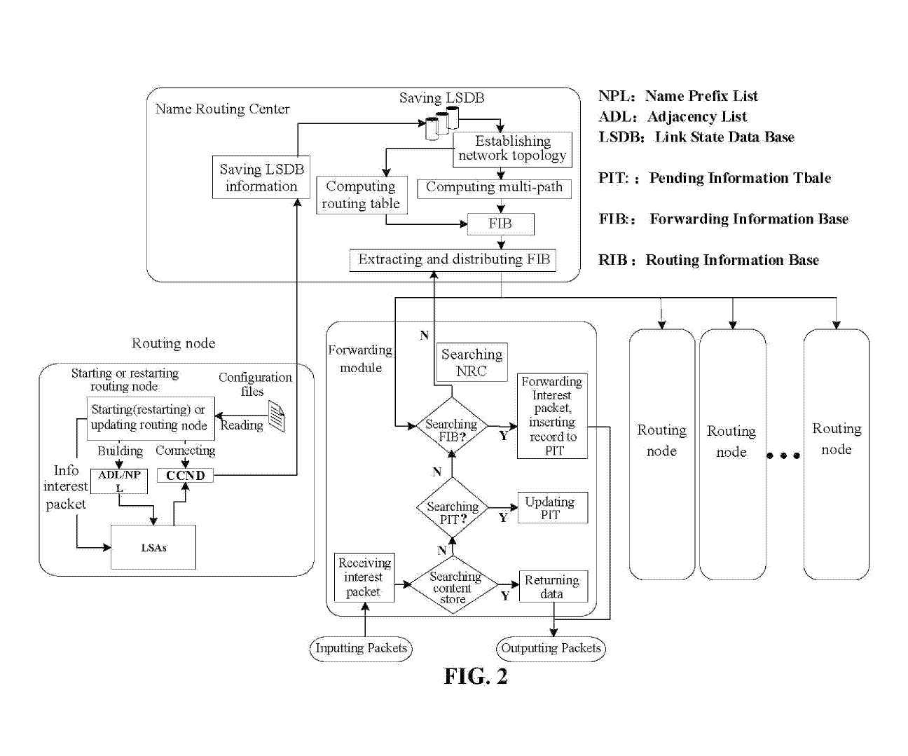

A general block diagram is shown in FIG. 2. The NRC of the controller is responsible for the topology discovery and maintenance, centralized routing computation, and routing information inquiry. Two threads are realized in the process of the routing node. One thread is responsible for detecting and gathering the link state and building the local LSDB, and the other thread is responsible for receiving and installing the FIB entries distributed from the controller. The NRC is responsible for gathering the LSDBs of each router, routing computation, and distributing routing tables. The routing node only maintains the link state between the directly connected routers and itself.

ALSA and the NLSA are defined by NLSR as shown in Table 1.

TABLE 1

| LSA Type | Contents |
|---|---|
| ALSA | Name of Neighbor 1, Cost of Link 1; Name of Neighbor 2, |
| | Cost of Link 2; . . . Name of Neighbor N, Cost of Link N; |
| NLSA | Validity identification; naming prefix. |

Hereinbelow, a realized main data packet format is defined:

TABLE 2
Configuration command
ccnneighbor /network/site/router IPAddress

| | |
|---|---|
| /network/site/ | Variable-length character type, directly connected routing |
| router | name, such as /pkusz.edu/A217/S2 |
| IPAddress | IP address for neighbor nodes, such as 10.15.7.26 |

router-name /network/site/router

| | |
|---|---|
| /network/site/ | Variable-length character type, local router name, such as |
| router | /pkusz.edu/A217/S2 |

ccnname /name/prefix

| | |
|---|---|
| name_prefix | Name prefix serviced by the present router |

lsdb-synch-interval lsi_secs

| | |
|---|---|
| lsi_secs | Integer type; a maximum time interval the neighbor node |
| | requests to the LSDB, and the default is 300. |

Interest-resend-time irt_secs

| | |
|---|---|
| irt_secs | Integer type; times for timeout resending of the Interest |
| | packet, and the default is 15. |

lsa-refresh-time lrt_secs

| | |
|---|---|
| lrt_secs | Integer type; time interval for NBCR updates its LSA, |
| | and the default is 1800. |

router-dead-interval rdi_secs

| | |
|---|---|
| rdi_secs | Integer type; time interval that the NBCR does not |
| | receive any information within a certain period and the |
| | neighbor node is considered to be dead. |

multi-path-face-num num

| | |
|---|---|
| num | Maximum port number added to the NBCR, and the |
| | default is 30 standing for 30 Faces. |

logdir path/to/log/dir

| | |
|---|---|
| path/to/log/dir | Variable-length data type; path that the NBCR records |
| | logs. |

TABLE 3
Adjacency LSA Header
Adjacency LSA Header

| | |
|---|---|
| Origination router | Source routing name (variable length) |
| Origin Router Length | Source routing name length (integer value) |
| LS Type | Type of LSA (8-bit unsigned integer value) |
| Origination Time | Starting timestamp (in milliseconds) of LSA for |
| | distinguishing LSA |
| isValid | Whether LSA is valid; value 1 stands |
| | for valid, then LSA is added to the LSDB; |
| | and 0 stands for non-valid, then LSA |
| | should be deleted if it exists in the LSDB. |

TABLE 4
Name LSA Header
Name LSA Header

| | |
|---|---|
| Origination router | Source routing name (variable length) |
| Origin Router Length | Source routing name length (integer value) |
| LS Type | 8-bit unsigned integer value standing |
| | for the type of LSA |
| LS Sequence Number | Sequence number of the link state for |
| | distinguishing LSA at the same router |
| Origination Time | Starting timestamp (in milliseconds) of LSA for |
| | distinguishing LSA |
| LS Id | LSA identifier, integer value |
| isValid | Whether LSA is valid; value 1 stands for |
| | valid, then LSA is added to the LSDB; |
| | and 0 stands for non-valid, then LSA |
| | should be deleted if it exists in the LSDB. |

TABLE 5
Adjacency LSA Body
Adjacency LSA Body
Number of Neighbors (Unsigned Integer 4 bytes)

| | |
|---|---|
| Neighbor 1 router name | Port of Neighbor 1 |
| (Variable length /name/prefix) | (4-bit unsigned integer value) |
| Neighbor 1 link cost | Link cost of Neighbor 1 |
| Neighbor 2 router name | Linkage identification of Neighbor 2 |
| Neighbor 2 link cost | Link cost of Neighbor 2 |
| . . . | |
| Neighbor n router name | Linkage identification of Neighbor n |
| Neighbor n link cost | Link cost of Neighbor n |

TABLE 6
Name LSA Body
Name LSA Body

| | |
|---|---|
| Name prefix (Variable | For example, variable length/name/prefix (unsigned |
| length/name/prefix) | integer value) |

1. Denomination

The routing node adopts hierarchical denomination, and each router is denominated according to its network and a self-defined router name, i.e., /<network>/<site>/<router>. For example, a router S1 in A217, Peking University Shenzhen Graduate School can be denominated as /pkusz.edu/A217/S1.

The routing node process is denominated after the router name, that is, /<network>/<site>/<router>/FARI. This name prefix is used in discovery of link failure between routers and info information for periodical communication.

The denomination of the LSA is started with

/<network>/<site>/<router>/FARI/LSA to explicitly indicate the router where the LSA is originated. The name prefix of the LSA is temporarily defined as /<LSA-Prefix>, herein the ALSA and the NLSA are defined by NLSR as shown in Table 1. The format of each ALSA is /<LSA-prefix>/LsType.1/<version>, and the format of NLSA is /<LSA-prefix>/LsType.2/LsId.<ID>/<version>. <version> represents different versions of the LSA.

2. Communication

Herein the communication process between different routers and between routers and the controller are specifically explained.

The router terminal:

When starting the router:

The router reads the configuration files when being started, and the configuration commands are listed in Table 2. After the reading, the router name is set, and an ADjacent List (ADL), a NPL, and other settings are built. The routing node is connected to the local CCNx Daemon (CCND) and <router-name>/fari is registered to the CCND, so that the interest packet of <route-name>/fari requested to the CCND is forwarded to routing node process for treatment.

Updating the ADL:

The routing node sends the info interest packet to all the directly connected routers thereof. When the routing node receives a response to the info interest packet from a certain directly connected router, a state filed of such neighbor is converted into “Active”; and when the sending time is out (which is determined by “interest-resend-time”), the interest packet is then resent for “interest-resend” times, and the state field of the neighbor is converted to “down” if no response is given. The directly connected router returns a content comprising its LSDB version and info information version when receiving the info interest packet.

Initialization of the LSA:

The router reads the NPL and builds the NLSA to add the NLSA to its LSDB, and reads and adds the entries with the “Active” state filed to the ALSA and installs the entries into the LSDB.

Synchronization of the LSDB:

When updating the LSA, each routing node sends the LSAs to the NRC, and the NRC executes a corresponding action.

Building the FIB:

After the routing node receives npt_entry, the routing node is connected to the CCND for changing the FIB, and the FIB is required to be reinstalled every time its npt_entry item is updated.

Link break/reconnection monitoring:

The function of sending the info interest packet when updating the ADL is to monitor whether the detected link is broken. The routing node updates and delivers the ADL and the ALSA to the NRC in breaking and reconnection of the link.

NRC terminal:

After acquiring the LSAs from the routing node, the NRC adds the content of the LSAs to the LSDB and establishes the entire network topology and computing the routing according to the ALSAs of the LSDB, and then establishes a Harsh list of an element npt_entry for each router so as to enable the NLSAs to correspond with the ALSAs. Table 7 lists one entry npt_entry of /ndn/pkusz.edu/s1, Adjacent Router stands for the name of a directly connected router, Name List stands for the content name prefixes distributed via the directly connected router, and Face List stands for the Face and the routing cost from a certain router to its directly connected router.

TABLE 7
npt_entry entry

| | |
|---|---|
| npt_entry entries | Examples |
| Adjacent Router | /ndn/pkusz.edu/s2 |
| Name List | /ndn/pkusz.edu/s2; |
| | /ndn/pkusz.edu/s2/alab2; |
| | /ndn/pkusz.edu/s2/blab2; |
| Face List | Face: 7 Route_Cost: 10.000000 |

A multi-source shortest path is computed by Floyd algorithm after the entire network topology is established by the NRC, and corresponding parts of a RIB are returned to the routing nodes via the expanded OpenFlow protocol. FIB entries are returned to the routing nodes in the form of an npt_entry set which comprises routers and content name prefixes of the entire network, and each router reinstalls the FIB according to the npt_entry set. When a number of the entries is larger than a set threshold, a part of the entries are selected as the FIB of each routing node.

Routing computation:

The NRC acquires the LSAs from each router to build an LSDB of an entire network. The ALSA comprises link information from one router to another router. Thus, a matrix W can be established, Wᵢⱼ stands for a link cost from router i to router j, and a shortest path between any two nodes and a next hop can be computed according to the Floyd algorithm Once the ALSA changes, the routing is recomputed or incrementally computed.

The follow definition is made:

$${W}_{ij} = \{ \begin{matrix}0 & when i = j \\ link cost from routing node i to j & \\ when i \neq j and ( i , j ) is directly connectable & \\ ∞ & other conditions\end{matrix}$$

The Floyd-Warshall algorithm is a dynamic programming algorithm. Defining that dᵢⱼ^{(k)} is a shortest path weight and numbers of all intermediate nodes on paths from node i to j are all selected from the a set {1, 2, . . . , k}. When k=0, a path from the node i to j not containing intermediate nodes labeled with a number larger than 0 exists with no intermediate node, thus, dᵢⱼ⁽⁰⁾=Wᵢⱼ. Recursive definition of dᵢⱼ^{(k)} is as follows:

$${d}_{ij}^{( k )} = \{ \begin{matrix}{W}_{ij} & k = 0 \\ min ( {d}_{ij}^{( k - 1 )} , {d}_{ik}^{( k - 1 )} + {d}_{kj}^{( k - 1 )} ) & k \geq 1 ,\end{matrix}$$

and the matrix D⁽ⁿ⁾=(dᵢⱼ⁽ⁿ⁾) is the final shortest path.

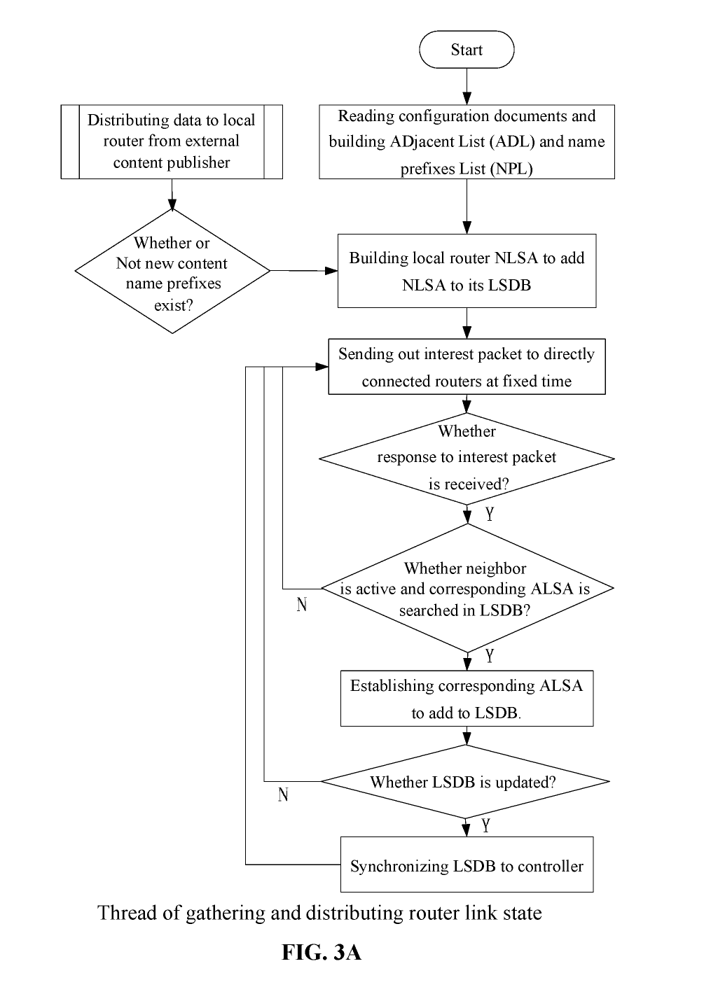

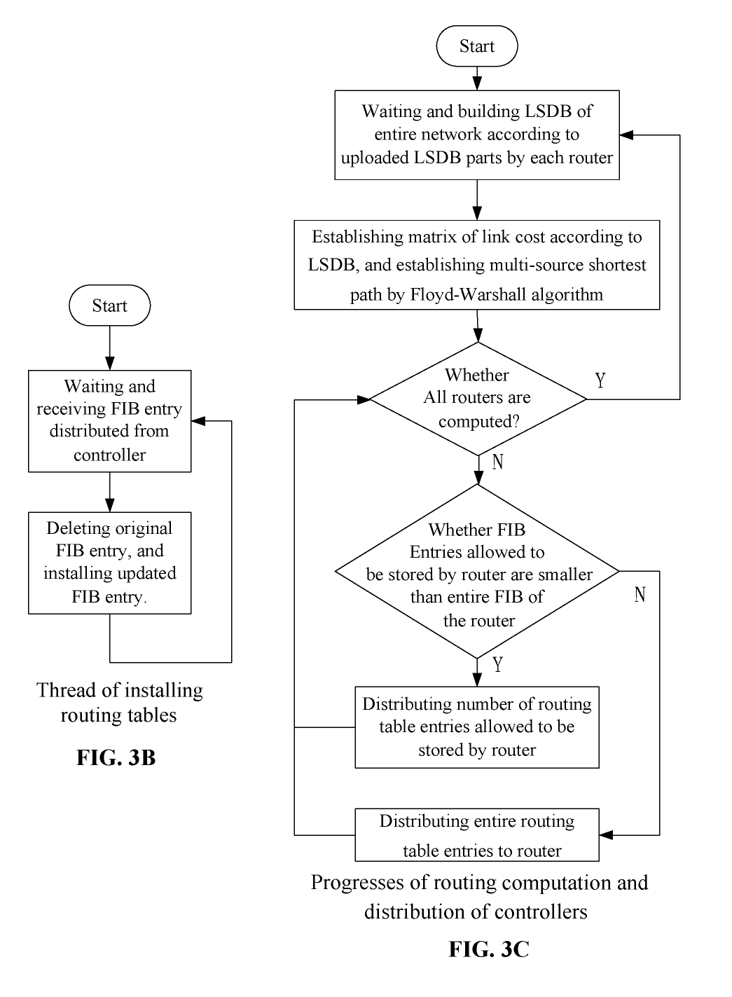

As shown in FIGS. 3A-3C, two threads are realized in the process of the routing node. One thread is responsible for detecting and gathering the link state and building the local LSDB, and the other thread is responsible for receiving and installing the FIB entries distributed from the controller. The controller is responsible for gathering the LSDBs of each router, routing computation, and distributing routing table entries.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A content-based routing method, comprising:
a) performing routing topology discovery and maintenance, centralized routing computation, and routing information inquiry by a name routing center (NRC) of a controller;
b) caching active routing information by a forwarding information base; and
c) acquiring inquired information of a routing node and updating the forwarding information base by the name routing center of the controller.

2. The method of claim 1, wherein in a), after acquiring link state advertisements from the routing node, the name routing center of the controller adds the link state advertisements to a link state database; the name routing center then establishes an entire network topology and computes the routing, and establishes a Harsh list of one element for each router so as to enable name link state advertisements to correspond with adjacency link state advertisements.

3. The method of claim 1, wherein
a multi-source shortest path is computed in a) after an entire network topology is built by the name routing center, and corresponding parts of a routing information base are returned to the routing nodes;
entries of the forwarding information base are returned to the routing nodes in the form of a set which comprises routers and content name prefixes of the entire network, and each router reinstalls the forwarding information base;
when a number of the entries is larger than a set threshold, a part of the entries are selected as the forwarding information base of each routing node.

4. The method of claim 1, wherein the routing node distributes link state advertisements thereof and sends an Info interest packet to directly connected routers to acquire a link state information.

5. The method of claim 1, wherein in c), after the routing node receives an Interest packet, following steps are performed:
c1) searching a content store: when a matching request content is found in the content store, sending the content to a request port, otherwise, forwarding the request content to a pending information table;
c2) searching the pending information table: when one Interest in the pending information table matches, which means that an information of the same Interest has been forwarded and is still waiting, adding a port the latest Interest information arrived on to the pending information table, otherwise, searching the forwarding information base;
c3) searching the forwarding information base: when a next hop routing which matches the Interest packet is found in the forwarding information base, forwarding the Interest packet to a next hop router, and adding the waiting information of the Interest packet to the pending information table; otherwise, sending a query command to search the name routing center; and
c4) searching a routing information base: searching a corresponding entry of the forwarding information base by the name routing center according to a routing information base thereof, and returning the corresponding entry of the forwarding information base to the routing node.

6. The method of claim 1, wherein the routing computation of a) comprises:
acquiring the link state advertisements from each router to build a link state database of an entire network, wherein an adjacency link state advertisement comprises link information from one router to another router;
establishing a matrix W, wherein Wᵢⱼ represents a link cost from router i to router j, computing a shortest path between any two nodes and a next hop by a Floyd algorithm, and recomputing the routing or incrementally computing the routing every time the adjacency link state advertisement changes;
defining dᵢⱼ^{(k)} as a shortest path weight from node i to j, in which numbers of all intermediate nodes on paths from node i to j are selected from a set {1, 2, . . . , k}; wherein
when k=0, no intermediate node exists on a path from node i to j not containing intermediate nodes labeled with a number larger than 0, dᵢⱼ⁽⁰⁾=Wᵢⱼ; and
recursively defining dᵢⱼ^{(k)} as follows:
$${d}_{ij}^{( k )} = \{ \begin{matrix}{W}_{ij} & k = 0 \\ min ( {d}_{ij}^{( k - 1 )} , {d}_{ik}^{( k - 1 )} + {d}_{kj}^{( k - 1 )} ) & k \geq 1 ,\end{matrix}$$
and obtaining the matrix D^{(n)=(d}ᵢⱼ⁽ⁿ⁾) as a final shortest path.

7. The method of claim 1, wherein two threads are realized in a process of the routing node in c): one thread is responsible for detecting and gathering link states and building a local LSDB, and the other thread is responsible for receiving and installing entries of the forwarding information base distributed from the controller.

8. The method of claim 1, wherein the routing node only maintains a link state between directly connected routers and the routing node.

9. The method of claim 1, wherein the name routing center manages entire network routing, and each router adopts a lookup-and-cache module.

10. A content-based routing system, comprising: a name routing center of a controller and multiple routing nodes connected thereto; wherein
the name routing center of a controller is responsible for routing topology discovery and maintenance, centralized routing computation, and routing information inquiry;
two threads are realized in a process of each routing node, one thread is responsible for detecting and gathering link states and building a local link state database, and the other thread is responsible for receiving and installing entries of a forwarding information base distributed from the controller;
the name routing center is also responsible for gathering the link state database of each router, routing computation, and distributing routing table entries; and
the routing node only maintains a link state between directly connected routers and the routing node.
